(19) United States
(12) Patent Application Publication
(10) Pub. No.: US 2021/0309313 A1
(43) Pub. Date: Oct. 7, 2021

(54) AIR VALVE REFLECTOR FOR A VEHICLE, AND KIT, WHEEL AND BICYCLE CONTAINING

(71) Applicant: STRATEGIC SPORTS LIMITED, Hong Kong (HK)

(72) Inventor: Jean-Pierre Garnier, Generargues (FR)

(21) Appl. No.: 17/210,672

(22) Filed: Mar. 24, 2021

(30) Foreign Application Priority Data
Apr. 1, 2020 (EM) 007783642-0001
Apr. 1, 2020 (EM) 007783642-0002
Apr. 1, 2020 (EM) 007783642-0003
Apr. 1, 2020 (EM) 007783642-0004
Apr. 1, 2020 (FR) 2003251
Apr. 1, 2020 (GB) 007783642-0001
Apr. 1, 2020 (GB) 007783642-0002
Apr. 1, 2020 (GB) 007783642-0003
Apr. 1, 2020 (GB) 007783642-0004

(51) Int. Cl. B62J 6/20; G02B 5/09; G02B 5/10; B60C 29/06

(52) U.S. Cl. CPC B62J 6/20; B60C 29/066; G02B 5/10; G02B 5/09

(57) ABSTRACT

A reflector for a vehicle wheel, or a bicycle wheel, contains an air valve attachment, and a reflective surface affixed to the air valve attachment. The reflective surface contains a portion which is aligned perpendicular to the axis of the air valve attachment. A bicycle wheel and a kit are also described herein.

### CROSS-REFERENCE TO RELATED APPLICATION

The present application claims the benefit of France Patent Application No. 2003251 filed Apr. 1, 2020, and also the benefit of European Union Intellectual Property Office Community Design Application Nos. 007783642-0001, 007783642-0002, 007783642-0003, and 007783642-0004, all filed on Apr. 1, 2020, and also the benefit of United Kingdom Design Application Nos. 007783642-0001, 007783642-0002, 007783642-0003, and 007783642-0004, all filed on Apr. 1, 2020, the disclosures of which are hereby incorporated by reference in their entireties.

### FIELD OF THE INVENTION

The present invention relates to safety devices for a vehicle and specifically the present invention relates to a reflector for a bicycle.

### BACKGROUND

With increasing numbers of people riding bicycles for health and pleasure, there arises a need for increased bicycle safety. Drivers, such as car drivers, are especially a danger to bicyclists during the dusk and evening hours as bicyclists may be difficult to see. Traditionally, bicycles may contain a reflector at the rear to help drivers behind the rider to increase the bicycle and riders' visibility. Typical reflectors may also be located on the spokes of a bicycle and reflect light perpendicular to the direction of the bicycle.

In addition, bicycles may contain lamps or lights in the front and/or back to help drivers increase visibility as well. In some cases battery-operated lights are known to be attached to the air valves of the bicycle tires. However, such powered devices typically require batteries which may be dense and heavy, and many bicyclists wish to reduce weight as much as possible. In addition, a battery-operated device needs to be recharged and/or the batteries need to be replaced periodically. Such batteries therefore can be troublesome for the rider and/or which the rider may forget about. This could then lead to inactive lights at times when the rider wants to use the bicycle.

In some cases, riders wear reflective clothing (i.e., clothing containing reflectors or a reflective material) to increase their visibility to drivers. Such clothing may include, for example, shoes, helmets, vests, jackets, leggings, pants, shorts, etc. However, in such cases, the rider must remember to wear these items of clothing every time.

Furthermore the inventors recognized that for fashion reasons, much modem exercise and other clothing is quite dark, or even black which reduces biker visibility for drivers. Accordingly, riders may not wish to wear clothing with reflective markings on them.

It is known that intermittent, i.e., flashing, lights draw more attention, i.e. are more conspicuous, than constantly lit lights. Accordingly, it has now been recognized and found that there is a need for improved, non-powered reflectors that are visible to a driver either in front of, or behind a bicycle rider. It has been found that there is an increased need for riders to be more conspicuous to drivers. It has also been found that there exists a need for reflectors that provide an intermittent reflection. It has also been found that there exists a need for reflectors that are typically present on the bicycle at all times and which the rider does not need to specifically wear/add/bring/etc.

### SUMMARY OF THE INVENTION

An embodiment of the present invention relates to a reflector for a vehicle wheel, or a bicycle wheel, containing an air valve attachment, and a reflective surface affixed to the air valve attachment. The reflective surface contains a portion which is aligned perpendicular to the axis of the air valve attachment.

Another embodiment of the present invention relates to a bicycle wheel comprising a reflector as described herein.

Another embodiment of the present invention relates to a kit for adapting a bicycle comprising a reflector as described herein.

Without intending to be limited by theory it is believed that the present invention may provide significantly improved visibility to a vehicle; or a bicycle, when ridden during the night. It is believed that when, for example, viewed by a driver approaching the bicycle, the rotating reflector may protrude from behind the width of the tire and create a flashing strobing, and/or pulsating effect which may alert the driver to the presence of the bicyclist. Furthermore, as the pattern observed by the driver is unique to a bicycle wheel, and different than, for example, a fixed flashing light at the rear of another vehicle, it may uniquely indicate to the driver that he/she is approaching a cyclist, as opposed to another type of vehicle. In addition, it is believed that in many cases, the reflector will be visible from both in front of as well as behind the cyclist.

The reflector herein is easy to use as it may be simply placed over the wheel's air valve, and/or the air valve cap. Furthermore, as the reflector herein may be attached to the bicycle wheel at all times (except during repair and/or adding air to the wheel), the cyclist does not need to remember to specifically add it to a bicycle before riding. As the reflector herein does not require any internal electricity, there are also no batteries to run out and/or no need for recharging. Accordingly, it is believed that the present invention may significantly improve road safety, especially for cyclists, as well as be easy and maintenance-free to use.

### BRIEF DESCRIPTION OF THE DRAWINGS

FIG. 1 shows a perspective view of an embodiment of a reflector of the present invention;

FIG. 2 shows a partial side view of an embodiment of a reflector of the present invention, and a bicycle wheel;

FIG. 3a shows a side view of an embodiment of the reflector of FIG. 1;

FIG. 3b shows a side view of an alternate embodiment of the reflector of the present invention;

FIG. 3c shows a side view of an alternate embodiment of the reflector having a curved surface;

FIG. 3d shows a side view of an alternate embodiment of the reflector of the present invention lacking a stem;

FIG. 3e shows a cross-sectional view of an embodiment of the reflector of FIG. 3b with the internal threads visible;

FIG. 4a shows a top-view of the reflector of FIG. 3b having a circular first surface, which corresponds to a reflective surface shape of a circle;

FIG. 4b shows a top-view of an embodiment of a reflector of the present invention having a reflective surface shape of an arrow;

FIG. 4c shows a top-view of an embodiment of a reflector of the present invention having a reflective surface shape of a rectangle;

FIG. 5 shows a front view of a vehicle containing the reflector of the present invention.

The figures herein are for illustrative purposes only and are not necessarily drawn to scale.

### DESCRIPTION OF THE PREFERRED EMBODIMENTS

Unless otherwise specifically provided, all tests herein are conducted at standard conditions which include a room and testing temperature of 25° C., sea level (1 atm.) pressure, pH 7, and all measurements are made in metric units. Furthermore, all percentages, ratios, etc. herein are by weight, unless specifically indicated otherwise. It is understood that unless otherwise specifically noted, the materials compounds, chemicals, etc. described herein are typically commodity items and/or industry-standard items available from a variety of suppliers worldwide.

An embodiment of the present invention relates to a reflector for a bicycle wheel containing an air valve attachment and a reflective surface affixed to the air valve attachment, wherein the reflective surface comprises a portion which is aligned perpendicular to the axis of the air valve attachment.

Bicycle wheels typically contain a hub containing an axle, a rim and spokes connecting the rim and the hub. Modern bicycle wheels contain tubular tires (a.k.a., a tub, a sew-up, a single etc.) that are typically glued to the rim. The tubular tires contain an inner tube to which air which is added via an air valve. The air valve is typically an industry-standard Presta valve (e.g., external threads=6 threads/inch×0.8 mm@; 6V1) or a Schrader valve (e.g., external threads=32 threads/inch×7.747 mm; tap size 8v1-32). The valve threads are measured according to the ISO 4570 standard. The air valve typically projects through a hole in the rim towards the hub. The air valve typically has a screw-on valve cap which protects the valve, reduces air leakage, prevents dirt and other materials from clogging the valve, etc.

The air valve attachment useful herein is designed to attach to the air valve, either directly or indirectly. For example, it may be designed to replace a valve cap or it may be designed to fit over a valve cap, as desired. Accordingly, in an embodiment herein, the air valve attachment is hollow, or partially hollow.

The reflective surface useful herein is a non-powered surface which reflects incoming light back towards the source. Reflective materials are well-known for use in a variety of uses, such as for normal bicycle reflectors, clothing, children's backpacks, road markings, signs, emergency equipment and clothing, etc., typically with the purpose of alerting to increase safety in low light conditions. As opposed to a mirror, which only reflects light in a single direction, the reflective material herein may reflect light in either a single or multiple directions relative to the light source. Reflective materials are well-known in the art and may be formed of a yarn, a textile, a plastic, a glass, a film, a foil, and a combination thereof.

The reflective material useful herein is typically intended to reflect visible light, although may also reflect infrared and/or ultraviolet light as desired, and may be selected from the group of a retroreflective material, a diffuse reflector material, a mirror, a glass surface, a plastic surface, a resin surface, a reflective textile, and a combination thereof; or a retroreflective material, a diffuse reflector material, a plastic surface, a resin surface, and a combination thereof; or a retroreflective material, and a combination thereof. In an embodiment herein, the retroreflective material contains a retroreflective material, such as a T2 retroreflective material, and/or a Class B retroreflective material. In an embodiment herein the retroreflective material is an adhesive retroreflective material; the adhesive retroreflective material may be selected from the group of a sticker, a decal, a label, a vinyl decal, a tape, a sheet, a film, and a combination thereof; or a SOLAS Marine Reflective Tape, a High Intensity Reflective Tape, a DOT Reflective Tape, a DOT C2 Reflective Tape, an ECE 104 Reflective Tape, a High Intensity Prismatic Reflective Tape, a Reflective PCV Tape, and a combination thereof. In an embodiment herein, the reflector and/or the reflective material is made of a recyclable material; or a recycled material.

The retroreflective material may contain glass beads therein which help to reflect light back towards the source. More specifically, the retroreflective material herein may contain, for example, may contain a cat's eye reflector, a corner reflector, a phase-conjugate mirror, and a combination thereof; a cat's eye reflector, a corner reflector, and a combination thereof; or a cat's eye reflector, a corner reflector, and a combination thereof.

Aside from reflectivity, other considerations for the selection of the reflective material are durability, especially against impacts from debris, rocks, pebbles, sand, etc. which a bicycle wheel would be expected to encounter, weight, water resistance, weather resistance, etc. which may be decided by the artisan.

In an embodiment herein, the reflective surface is contained on a perpendicular plane, indicating a plane which is perpendicular to the bicycle's intended direction of travel. In an embodiment herein, the air valve attachment contains an axis which is coaxial with the air valve that the air valve attachment is to be affixed to during use, and the perpendicular plane is perpendicular to the axis of the air valve attachment. In an embodiment herein, the perpendicular plane is perpendicular to the plane formed by the bicycle wheel, or perpendicular to the plane formed by the bicycle wheel's rim. The perpendicular plane may include the reflective surface, for example, thereupon, affixed thereto, and/or formed therewith/therefrom.

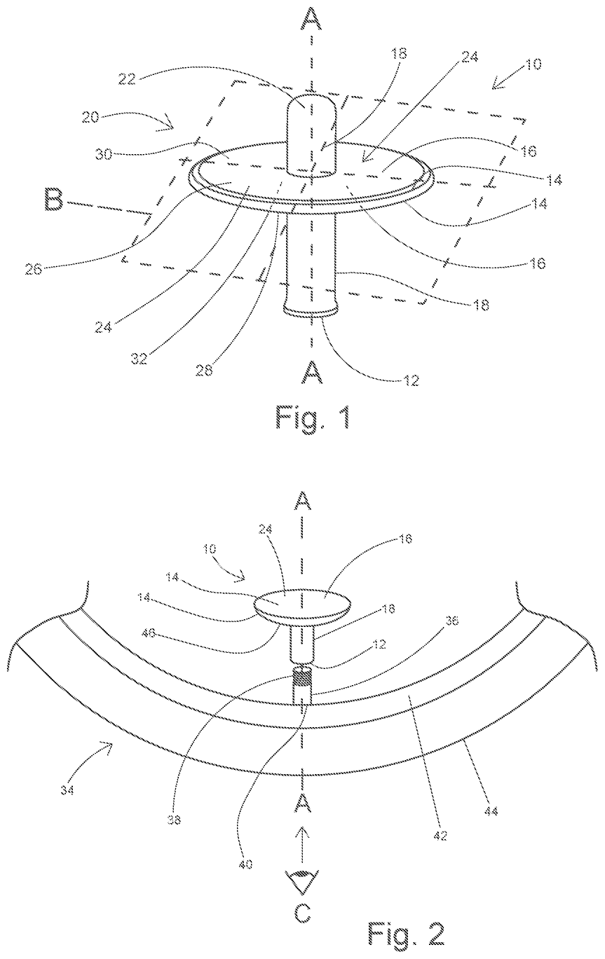

In an embodiment herein, the reflective material is visible at night from at least about 250 meter. In an embodiment herein, the reflective material is visible from a variety of angles, or from at least from about 10 degrees to about 85 degrees, or from about 15 degrees to about 75 degrees, or from about 20 degrees to about 70 degrees as measured from the stem axis, A-A (see FIG. 1), as described herein.

In order to maximize the reflections provided, an embodiment herein includes where the perpendicular plane contains a first surface, which may be a plane surface, that is distal to the air valve attachment and a second surface, which may be a second plane surface, opposite to the first plane surface. The first surface; or the first plane surface may contain a first reflective surface, and the second surface; or second plane surface may contain a second reflective surface. The first reflective surface and the second reflective surface may be arranged to reflect light in opposite directions.

The reflector herein may reflect light in one or more colors, meaning that the reflective surfaces themselves may be reflective to only certain colors, or may contain a colored tint, filter, etc. which transforms white light incident on the reflector into colored light upon return to the light source/driver. The color of the reflected light returned to the light source/driver is referred to herein as the reflected color. Accordingly, in an embodiment herein the reflective surface reflects light in a reflected color; or a plurality of reflected colors. Preferred reflected colors (i.e., colors observed by a driver) herein include white (i.e., all visible light wavelengths), red, yellow, orange, pink, green, blue and a combination thereof; white, red, yellow, orange, green, and a combination thereof. While it is recognized that white light is not actually a single color, for the ease of understanding the term “white” is used herein to indicate a substantially complete reflection of all wavelengths of light incident upon the reflective surface, in proportion to their original intensity.

In an embodiment herein, the first reflective surface reflects light in a first reflected color, and wherein the second reflective surface reflects light in a second reflected color. In an alternate embodiment herein, the first reflective color is the same as the second reflective color. In an embodiment herein, the first reflective color is the different from the second reflective color. In an embodiment herein, a reflector intended to be placed on the front wheel of a vehicle; or a bicycle, reflects white colored light. In an embodiment herein, a reflector intended to be placed on the rear wheel of a vehicle; or a bicycle, reflects red colored light.

In an embodiment herein, the reflector and any surface therefor, is directly attached to the air valve attachment, In an alternate embodiment herein, the reflector further contains a stem located between the air valve attachment and the reactive surface. The stem may connect the air valve attachment to the reflective surface. The stem may be hollow, or partially hollow, as desired.

The reflector herein may contain a first shape, and/or a second shape which is arranged in any shape as desired. The first shape and the second shape will in turn typically determine the reflective surface shape. In an embodiment herein, the reflective surface shape selected from the group consisting of a circle, an arrow, a triangle, a rectangle, an ovoid, a pentagon, a hexagon, an octagon, and a combination thereof; or a circle, an arrow, a triangle, a rectangle, an oval, a pentagon, a hexagon, an octagon, and a combination thereof.

In an embodiment herein, the reflective material substantially covers the entire surface area of the reflective surface shape; or covers the entire surface area of the reflective surface shape.

In an embodiment herein, the reflective surface may contain a curved surface, such as a hemisphere, an arc, a waveform, and a combination thereof; or a partial spheroid, an arc, and a combination thereof; or a partial spheroid, and a combination thereof.

In an embodiment herein, a bicycle wheel contains the reflector herein; or a reflector as described herein is affixed to the air valve of a bicycle wheel. In an embodiment herein, the reflective surface is wider than the bicycle wheel, so as to allow it to be reflect light back to the light source when it is mounted on the air valve of the bicycle wheel. Accordingly, the reflective surface has a reflective surface width, and the bicycle wheel has a bicycle tire width. In an embodiment herein the reflective surface width is greater than the bicycle's tire width; or the reflective surface width is from about 10% greater to about 300% greater than the tire width; or the reflective surface width is from about 25% greater to about 250% greater than the tire width; or the reflective surface width is from about 50% greater to about 200% greater than the tire width

In an embodiment herein, the reflective surface width the reflective surface width is greater than the tire width; or the reflective surface width is from about 10 mm to about 75 mm; or from about 15 mm to about 70 mm; or from about 20 mm to about 50 mm; or from about 25 m to about 45 mm.

While the present invention is intended for a bicycle, it is recognized that it may be used on other vehicles other than a bicycle wheel, and that bicycle wheels may be used on vehicles other than bicycles, such as tricycles, carts, (what else?) and a combination thereof, with equivalent benefits and effect. In such a case, the reflector dimensions may be scaled accordingly. Accordingly, in an embodiment herein, a vehicle contains the bicycle wheel as described herein; or a plurality of bicycle wheels as described herein; or from about 2 to about 4 bicycle wheels; or from about 2 to about 3 bicycle wheels; or about 2 bicycle wheels. In an embodiment herein, the vehicle is a bicycle.

In some cases the reflector herein may be sold with a vehicle; or a bicycle; or a bicycle wheel. In other cases, the reflector herein may be sold in a kit to be added as an after-factory modification to a vehicle; or a bicycle; or a bicycle wheel.

Turning to the figures, FIG. 1 shows a perspective view of an embodiment of a reflector, 10, herein. The reflector, 10, contains an air valve attachment, 12, and a reflective surface, 14, affixed to and distal from the air valve attachment, 12. The reflective surface, 14, is in the shape of a disc containing reflective material, 16.

The air valve attachment, 12, is separated from the reflective surface, 14, by a stem, 18, which extends through a perpendicular plane, 20, to terminate at a top end, 22. The stem, 18, contains a stem axis, A-A, running the length of the stem, 18, from the air valve attachment, 12, to the top end, 22. The perpendicular plane, 20, is perpendicular to the stem axis, A-A. The top end, 22, may be useful for gripping the reflector, 10, such as when affixing it to the air valve (see FIG. 2 at 36), and/or removing it from the air valve (see FIG. 2 at 36).

In FIG. 1, a perpendicular plane, 20, is attached to the stem, and forms a plane, B; in this case, the perpendicular plane's first surface, 24, is flat, making it a first plane surface, 26. The perpendicular plane, 20, thus contains the first plane surface, 26, distal from the air valve attachment, and a second plane surface, 28, opposite the first plane surface, 26. The first plane surface, 26, contains a first reflective surface, 30, while the second plane surface, 28, contains a second reflective surface, 32. The second reflective surface, 32, is closer to the air valve attachment, 14, than the first reflective surface, 30. In FIG. 1, the first reflective surface, 30, reflects light in a first reflected color, for example, red, while the second reflective surface, 32, reflects light in a second reflected color, for example, white.

FIG. 2 shows a partial side view of an embodiment of a reflector, 10, as described herein and a bicycle wheel, 34. The air valve attachment, 12, of the stem, 18, contains a stem axis, A-A. The stem axis, A-A, is aligned so as to be coaxial with the air valve, 36, when viewed from point C. In this case, the air valve attachment, 12, is designed to completely replace the normal air valve cap (not shown) by the air valve attachment, 12, screwing onto the threads, 38, of the air valve, 36. The Air valve, 36, protrudes from a hole, 40, in the metal rim, 42. A tubular tire, 44, surrounds the rim, 42.

The reflective surface, 14, is formed of a reflective material, 16, that is permanently in-moulded onto the perpendicular plane, 20, by methods known in the art. The first surface, 24, is flat, while a curved surface, 46, forms a second surface, 48, opposite the first surface, 24. The first surface, 24, is distal from the air valve, 36, while the second surface, 48, is proximal to the air valve, 36.

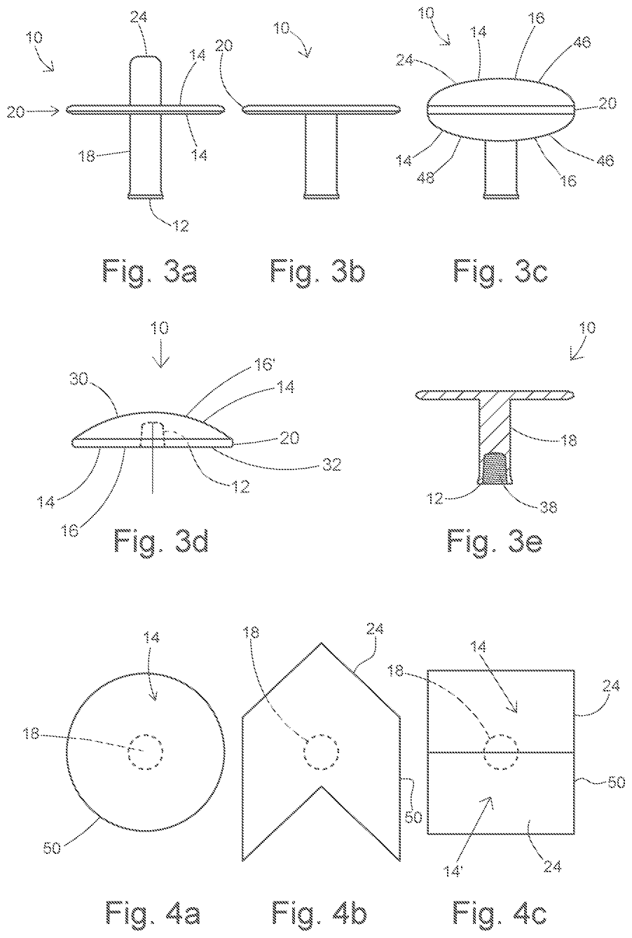

FIG. 3a shows a side view of an embodiment of the reflector, 10, of FIG. 1. The reflector, 10, has stem, 18, which begins at an air valve attachment, 12, extends through the perpendicular plane, 20, and terminates at a top end, 22. The perpendicular plane, 20, contains a reflective surface, 14, on each side.

FIG. 3b shows a side view of an alternate embodiment of the reflector, 10, herein, which does not contain a top end, but instead terminates at the first plane surface, 26, of the perpendicular pane, 20.

FIG. 3c shows a side view of an alternate embodiment of the reflector, 10, having a curved surface, 46 on both sides of the perpendicular plane, 20. Thus the first surface, 24, is a curved surface, 46, as is the second surface, 48, which is opposite the first surface, 24. The curved surfaces, 46, are partial spheroids in shape and contain the reflective surfaces, 14, which in turn contain the reflective material, 16.

FIG. 3d shows a side view of an alternate embodiment of the reflector, 10, lacking a stem. The reflector, 10, contains an air vale attachment, 12, which does not protrude from the perpendicular plane, 20, and in fact is flush with the perpendicular plane, 20. Reflective surfaces, 14, containing reflective material, 16, are present on both the first reflective surface, 30, as well as the opposing second reflective surface, 32.

FIG. 3e shows a cross-sectional view of an embodiment of the reflector, 10, in FIG. 3b with the internal threads, 38, of the reflector, visible. The air valve attachment, 12, of the stem, 18, contains a set of internal threads, 38, which are complementary to the threads (see FIG. 2 at 38) on the air valve (see FIG. 2 at 36).

FIG. 4a shows a top-view of the reflector, 10, of FIG. 3b having a circular first surface, which corresponds to a reflective surface shape, 50, of a circle. The reflective surface, 14, is facing the view, while the stem, 18, is facing away from the viewer.

FIG. 4b shows a top-view of an embodiment of a reflector, 10, having a reflective surface shape, 50, of an arrow. The first surface, 24 is in the shape of an arrow, and the reflective surface, 14, covers the entire first surface, 24. The stem, 18, is on the opposite side of the viewer.

FIG. 4c shows a top-view of an embodiment of a reflector, 10, having a reflective surface shape, 50, of a rectangle. The first surface, 24 is in the shape of an rectangle, and the reflective surface, 14, is divided into two reflective surfaces, 14 and 14′. Reflective surface, 14, reflects a first reflected color, for example, red, while reflective surface, 14′, reflects a second reflected color, for example, green. The stem, 18, is on the opposite side of the viewer.

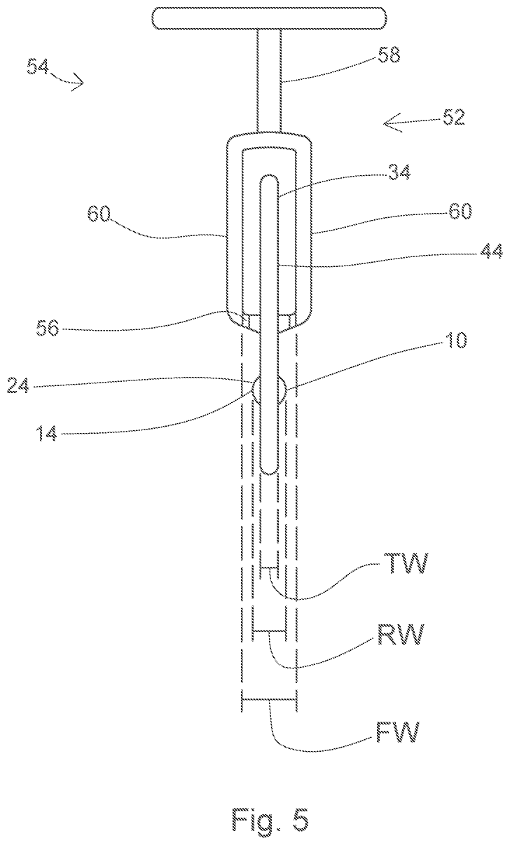

FIG. 5 shows a front view of a vehicle, 52, containing the reflector, 10, herein. The vehicle, 52, is a bicycle, 54, and the reflective surface, 14, on the first surface, 24, is visible to the viewer. The bicycle wheel, 34, has a tubular tire, 44, which in turn has a tire width, TW, and the reflective surface, 14, has a reflective surface width, RW. In order to be seen by a driver the reflective surface width, RW, should be greater than the tire width, TW, as described herein. This is because the reflector, 10, is attached inside of the bicycle wheel, 34, and inside of the tubular tire, 44. Thus, the tubular tire, 44, partially blocks the view of the reflective surface, 14. However, as the reflective surface width, RW is greater than the tire width, TW, at least a portion of the reflective surface, 14, is available to reflect light back to the light source (assumed to be at the driver's location) even if the light source is directly in front of or behind the bicycle/vehicle.

In this embodiment the reflective surface shape is symmetrical with respect to the plane formed by the bicycle tire. In addition, the reflector, 10, contains both a first reflective surface (see FIG. 1 at 26), and a second reflective surface (see FIG. 1 at 28). Therefore the driver would see four flashes for each rotation of the bicycle wheel a pair of flashes on the left and right sides of the bicycle wheel from the first reflective surface, and a pair of flashes on the left and right sides of the bicycle wheel from the second reflective surface.

The bicycle wheel, 34, will typically contain a hub, 56, which is connected to the bicycle frame, 58, by a pair of forks, 60, on each side of the bicycle wheel, 34. The distance between the forks, 60, is the fork width, FW. It is understood that in order not to reduce the chance of damage or a collision between the reflective surface, 14, and the forks, 60, during use, the reflective surface width, RW, should be less than the fork width, FW. This is true for both the front forks, and the rear forks of a bicycle. In an embodiment herein, the reflective surface width is more narrow than the fork width; or the reflective surface width is from about 10% more narrow to about 50% more narrow than the fork width; or the reflective surface width is from about 15% more narrow to about 45% more narrow than the fork width; or the reflective surface width is from about 20% less wide to about 400% less wide than the fork width.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

All references specifically cited herein are hereby incorporated by reference in their entireties. However, the citation or incorporation of such a reference is not necessarily an admission as to its appropriateness, citability, and/or availability as prior art to/against the present invention.

1. A reflector for a vehicle wheel, comprising:
A) an air valve attachment; and
B) a reflective surface affixed to the air valve attachment, wherein the reflective surface comprises a portion which is aligned perpendicular to the axis of the air valve attachment.

2. The reflector according to claim 1, further comprising:
a perpendicular plane, wherein the perpendicular plane comprises the reflective surface.

3. The reflector according to claim 2, wherein the perpendicular plane comprises a plurality of reflective surfaces.

4. The reflector according to claim 3, wherein the perpendicular plane comprises:
a first plane surface distal from the air valve attachment, the first plane surface comprising a first reflective surface; and
a second plane surface opposite to the first plane surface, the second plane surface comprising a second reflective surface,
wherein the first reflective surface and the second reflective surface are arranged to reflect light in opposite directions.

5. The reflector according to claim 4, wherein the first reflective surface reflects light in a first reflected color, and wherein the second reflective surface reflects light in a second reflected color.

6. The reflector according to claim 5, wherein the first reflective color is the same as the second reflective color.

7. The reflector according to claim 5, wherein the first reflective color is the different from the second reflective color.

8 The reflector according to claim 1, further comprising:
a stem, wherein the stem connects the air valve attachment to the reflective surface.

9. The reflector according to claim 1, wherein the reflective material is selected from the group consisting of a retroreflective material, a diffuse reflector material, a mirror, a glass surface, a plastic surface, a resin surface, a reflective textile, and a combination thereof, or a retroreflective material, a diffuse reflector material, a plastic surface, a resin surface, and a combination thereof, or a retroreflective material, and a combination thereof.

10. The reflector according to claim 1, wherein the reflective surface comprises a reflective surface shape selected from the group consisting of a circle, an arrow, a triangle, a rectangle, an ovoid, a pentagon, a hexagon, an octagon, and a combination thereof; or a circle, an arrow, a triangle, a rectangle, an oval, a pentagon, a hexagon an octagon, and a combination thereof.

11. The reflector according to claim 1, wherein the reflective surface comprises a curved surface.

12. The reflector according to claim 1, wherein the reflective surface comprises an adhesive backing.

13. The reflector according to claim 1, wherein the reflective surface comprises a reflective surface width, and wherein the reflective surface width is from about 10 mm to about 75 mm.

14. A bicycle wheel comprising a reflector according to claim 1.

15. The bicycle wheel according to claim 13, wherein the reflective surface comprises a reflective surface width, and wherein the reflective surface width is greater than the tire width.

16. A vehicle comprising the bicycle wheel according to claim 13.

17. The vehicle according to claim 16, wherein the vehicle is a bicycle.

18. A kit for adapting a bicycle comprising a reflector according to claim 1.

19. A reflector for a vehicle wheel comprising:
A) an air valve attachment;
B) a perpendicular plane comprising:
a first plane surface distal from the air valve attachment, the first plane surface comprising a first reflective surface; and
a second plane surface opposite to the first plane surface, the second plane surface comprising a second reflective surface,
wherein the first reflective surface and the second reflective surface are arranged to reflect light in opposite directions, and wherein the first reflective surface and the second reflective surface each compose a portion which is aligned perpendicular to the axis of the air valve attachment.

20. The reflector according to claim 19, wherein the first reflective surface reflects fight in a first reflected color, and wherein the second reflective surface reflects light in a second reflected color.
